(19) United States
(12) Patent Application Publication
(10) Pub. No.: US 2018/0279130 A1
(43) Pub. Date: Sep. 27, 2018

(54) ENHANCED CHANNEL SELECTION IN A NETWORK HAVING MULTIPLE ACCESS POINTS

(71) Applicant: QUALCOMM Incorporated, San Diego, CA (US)

(72) Inventors: Xiaolong Huang, San Jose, CA (US); Srinivas Katar, Fremont, CA (US); Sai Yiu Duncan Ho, San Diego, CA (US); Alireza Raissinia, Monte Sereno, CA (US); Brian Michael Buesker, San Diego, CA (US); George Cherian, San Diego, CA (US)

(21) Appl. No.: 15/927,901

(22) Filed: Mar. 21, 2018

Related U.S. Application Data
(60) Provisional application No. 62/476,637, filed on Mar. 24, 2017.

(51) Int. Cl. H04W 16/10; H04W 72/04

(52) U.S. Cl. CPC H04W 16/10; H04W 88/08; H04W 72/0453

(57) ABSTRACT

This disclosure provides systems, methods, and apparatus, including computer programs encoded on computer-readable media, for enhanced channel selection in a network having multiple access points (APs). The enhanced channel selection may optimize the overall performance of the network by incorporating considerations about the impact on other APs in a big-picture view of the network. In one aspect, enhanced channel selection may combine a first channel selection process at a first AP (based on first channel selection by the first AP) with a second channel selection at a Multi-AP Controller. Coordination between the first AP and the Multi-AP Controller may improve a channel selection technique to optimize channel selection based on considerations of the overall network.

### CROSS-REFERENCE TO RELATED APPLICATIONS

This patent application claims priority to U.S. Provisional Patent Application No. 62/476,637 filed Mar. 24, 2017 entitled “ENHANCED CHANNEL SELECTION IN A NETWORK HAVING MULTIPLE ACCESS POINTS”, and assigned to the assignee hereof. The disclosure of the prior application is considered part of and is incorporated by reference in this patent application.

### TECHNICAL FIELD

This disclosure relates to the field of network communication, and more particularly to channel selection in a network having multiple access points.

### DESCRIPTION OF THE RELATED TECHNOLOGY

Wireless communication technologies can support wireless network access for a device via an access point (AP). An AP may be communicatively coupled to a gateway (such as a cable modem, fiber optic network device, digital subscriber line (DSL) modem, or the like) to access a broadband network. The AP may provide a wireless network coverage area for one or more devices to access the broadband network via the AP. A network may include multiple APs capable of providing wireless network access. For example, first AP could be communicatively coupled to the broadband network, and a second AP can wirelessly connect to the first AP while extending the wireless network coverage area of the network. The second AP may operate similar to the first AP by receiving, buffering, and then relaying data to and from the first AP and a device that is wirelessly associated with the second AP. It is possible to combine multiple APs such that each AP is in communication with at least one other AP to provide a larger wireless coverage area with network access to the broadband network. The wireless coverage area provided by an AP may utilize a 2.4 GHz frequency band, a 5 GHz frequency band, or in both the 2.4 GHz frequency band and the 5 GHz frequency band. Within each frequency band, there may be different channels which an AP may utilize.

When a network includes multiple APs, it is desirable for nearby APs avoid using the same channel. For example, co-channel interference may occur between two APs that are using the same channel in overlapping coverage areas. Co-channel interference can severely affect the performance of a wireless network. A traditional channel selection technique is based on avoiding channels that are currently in use by a nearby AP. However, there may be a limited quantity of channels within a frequency band due to spectrum constraints. As the quantity of APs deployed in an area increases, it is desirable to use a channel selection technique that takes into account the topology, channel overlap, or other network considerations.

### SUMMARY

The systems, methods, and devices of this disclosure each have several innovative aspects, no single one of which is solely responsible for the desirable attributes disclosed herein.

One innovative aspect of the subject matter described in this disclosure can be implemented by a first access point (AP) of a network. The first AP may have a processor and memory. The memory may store instructions which, when executed by the processor cause the first AP to perform the operations described in this disclosure. The instructions may cause the instructions may cause the first AP toto send a first list of channels to a Multi-AP Controller of the network. The first list of channels may include channel selection information determined by the first AP. The instructions may cause the instructions may cause the first AP to receive, from the Multi-AP Controller, a second list of channels selected by the Multi-AP Controller. The second list of channels may be based, at least in part, on the first list of channels. The instructions may cause the instructions may cause the first AP toto utilize a first channel from among the second list of channels for providing a first wireless coverage area.

In some implementations, the instructions may cause the first AP to obtain channel condition information regarding a set of channels available for use by the first AP. The channel selection information may be based, at least in part, on the channel condition information. The instructions may cause the first AP to determine the first list of channels from among the set of channels, the first list of channels selected by the first AP based, at least in part, on a first channel selection by the first AP.

In some implementations, the instructions may cause the first AP to scan the set of channels and determine the channel condition information in response to scanning the set of channels.

In some implementations, the instructions to obtain the channel condition information from a second AP or the Multi-AP Controller.

In some implementations, the instructions may cause the first AP to send a query message to at least a second AP in the network. The instructions may cause the first AP to receive a response message from the second AP, the response message having at least a portion of the channel condition information.

In some implementations, the instructions may cause the first AP to send a query message to the Multi-AP Controller in the network. The instructions may cause the first AP to receive a response message from the Multi-AP Controller, the response message having the channel condition information regarding one or more other APs in the network.

In some implementations, the channel selection information includes at least one member selected from the group consisting of current channel condition information regarding a channel currently used by a second AP, operating capability information regarding operating capability of the second AP, a remote channel switch trigger condition associated with the second AP, and other channel condition information regarding other channels detected by the second AP.

In some implementations, the instructions may cause the first AP to detect a local channel switch trigger condition. The first list of channels may be sent in response to a detection of the local channel switch trigger condition.

In some implementations, the instructions may cause the first AP to receive a channel preference query message from the Multi-AP Controller or another AP in the network.

In some implementations, the instructions to detect the local channel switch trigger condition may include instructions which, when executed by the processor, cause the first AP to perform at least one operation selected from a group consisting of determining that the first AP has a load higher than a trigger threshold, determining a co-channel interference on a current channel being used by the first AP, wherein the co-channel interference is impacting channel availability for one or more stations associated with the current channel, comparing an interference power level with a threshold level, and comparing a current time with a trigger time configured at the first AP.

In some implementations, the instructions may cause the first AP to select the first list of channels based, at least in part, on the channel selection information. The instructions may cause the first AP to associate a preference score for each channel in the first list of channels.

In some implementations, the instructions to determine the first list of channels include instructions which, when executed by the processor, cause the first AP to, for at least one candidate channel from a set of channels, determine an effective channel capacity for the candidate channel, determine an estimated load impact to a neighbor AP that is already using the candidate channel, and/or determine a probability of triggering a remote channel switch trigger condition of the neighbor AP that would result from the first AP selecting the candidate channel.

In some implementations, the instructions may cause the first AP to determine a current available airtime of the candidate channel utilized by other neighbor APs in an overlapping coverage area that includes the first AP. The instructions may cause the first AP to determine an additional contention airtime of the candidate channel based, at least in part, on a quantity of stations associated with the first AP and the current available airtime. The instructions may cause the first AP to determine an estimated physical layer transmission data rate for the quantity of stations associated with the first AP. The instructions may cause the first AP to calculate the effective channel capacity based, at least in part, on the current available airtime, the additional contention airtime, and the estimated physical layer transmission data rate.

In some implementations, the instructions may cause the first AP to determine the remote channel switch trigger condition of the neighbor AP. The instructions may cause the first AP to estimate a resulting channel condition at the neighbor AP that would result from the first AP selecting the candidate channel. The instructions may cause the first AP to compare the resulting channel condition to the remote channel switch trigger condition.

In some implementations, the instructions to send the first list of channels may include instructions to send a Channel Preference Report message to the Multi-AP Controller. The instructions to receive the second list of channels may include instructions to receive a Channel Selection Request message from the Multi-AP Controller.

In some implementations, the second list of channels may comprise a subset of the first list of channels selected by the Multi-AP Controller based, at least in part, on a second channel selection by the Multi-AP Controller.

In some implementations, the instructions may cause the first AP to select the first channel from among the second list of channels. The instructions may cause the first AP to configure a transceiver of the first AP to communicate via the first channel.

In some implementations, the instructions may cause the first AP to send a channel switch finish message to the Multi-AP Controller to indicate that the first AP is utilizing the first channel.

Another innovative aspect of the subject matter described in this disclosure can be implemented by a Multi-AP Controller of a network. The Multi-AP Controller may have a processor and memory. The memory may store instructions which, when executed by the processor cause the Multi-AP Controller to perform the operations described in this disclosure. The instructions may cause the Multi-AP Controller to receive a first list of channels from a first AP of the network, the first list of channels selected by the first AP based, at least in part, on a first channel selection by the first AP. The instructions may cause the Multi-AP Controller to determine a second list of channels from among the first list of channels, the second list of channels selected by the Multi-AP Controller based, at least in part, on the first list of channels. The instructions may cause the Multi-AP Controller to send, to the first AP, the second list of channels to the first AP. The instructions may cause the Multi-AP Controller to cause the first AP to utilize a selected channel from the second list of channels.

In some implementations, the instructions may cause the Multi-AP Controller to send a Channel Preference Query message from the Multi-AP Controller to the first AP.

In some implementations, the instructions may cause the Multi-AP Controller to receive a Channel Preference Report message from the first AP. The instructions may cause the Multi-AP Controller send a Channel Selection Request message to the first AP.

In some implementations, the instructions may cause the Multi-AP Controller to, for at least one candidate channel from the first list of channels, determine an effective channel capacity for the candidate channel, determine an estimated load impact to a neighbor AP that is already using the candidate channel, and determine a probability of triggering a remote channel switch trigger condition of the neighbor AP that would result from the first AP selecting the candidate channel.

In some implementations, the instructions may cause the Multi-AP Controller to, for at least one candidate channel from the first list of channels, use a contention graph coloring algorithm to estimate the impact to the network that would result from the first AP selecting the candidate channel.

In some implementations, instructions may cause the Multi-AP Controller to utilize a contention graph coloring algorithm to maximize channel reuse in the network.

Another innovative aspect of the subject matter described in this disclosure can be implemented by a first AP for sharing channel condition information in a network. The first AP may receive a channel utilization query message from a second AP in the network. The first AP may determine a current channel utilization for a channel that is currently being utilized by the first AP. The first AP may determine other channel condition information regarding other channels detected by the first AP. The first AP may send a channel utilization response message to the second AP, wherein the channel utilization response message includes the other channel condition information.

In some implementations, the other channel condition information may include information about channels considered but not selected for use by the first AP.

Another innovative aspect of the subject matter described in this disclosure can be implemented as a method performed by a first AP. The first AP send a first list of channels to a Multi-AP Controller of the network, the first list of channels including channel selection information determined by the first AP, receive, from the Multi-AP Controller, a second list of channels selected by the Multi-AP Controller, wherein the second list of channels is based, at least in part, on the first list of channels, and utilize, by the first AP, a first channel from among the second list of channels for providing a first wireless coverage area.

In some implementations, the first AP may obtain channel condition information regarding a set of channels available for use by the first AP, wherein the channel selection information is based, at least in part, on the channel condition information. The first AP may determine the first list of channels from among the set of channels, the first list of channels selected by the first AP based, at least in part, on a first channel selection by the first AP.

In some implementations, the first AP may select the first list of channels based, at least in part, on the channel selection information, and associate a preference score for each channel in the first list of channels.

In some implementations, the second list of channels may comprise a subset of the first list of channels selected by the Multi-AP Controller based, at least in part, on a second channel selection by the Multi-AP Controller.

Another innovative aspect of the subject matter described in this disclosure can be implemented by a computer-readable medium having stored. The instructions, when executed by a processor of a first AP for use in a network, may cause the first AP to send a first list of channels to a Multi-AP Controller of the network, the first list of channels including channel selection information determined by the first AP, receive, from the Multi-AP Controller, a second list of channels selected by the Multi-AP Controller, wherein the second list of channels is based, at least in part, on the first list of channels, and utilize, by the first AP, a first channel from among the second list of channels for providing a first wireless coverage area.

In some implementations, the instructions to determine the target AP include instructions which, when executed by the processor, cause the first AP to obtain channel condition information regarding a set of channels available for use by the first AP, wherein the channel selection information is based, at least in part, on the channel condition information, and determine the first list of channels from among the set of channels, the first list of channels selected by the first AP based, at least in part, on a first channel selection by the first AP.

In some implementations, the second list of channels may comprise a subset of the first list of channels selected by the Multi-AP Controller based, at least in part, on a second channel selection by the Multi-AP Controller.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 depicts a system diagram of an example network with multiple access points (APs).

FIG. 2 depicts another system diagram showing wireless coverage areas of the multiple APs.

FIG. 3 depicts a flowchart of a first AP performing an enhanced channel selection.

FIG. 4 depicts a message flow diagram of example implementation of enhanced channel selection.

FIG. 5 depicts a message flow diagram of another example implementation of enhanced channel selection using channel utilization query messages.

FIG. 6 depicts a message flow diagram of another example implementation of enhanced channel selection using a root AP to collect channel condition information.

FIG. 7 depicts a message flow diagram of another example implementation in which a root AP manages enhanced channel selection.

FIG. 8 depicts an example conceptual diagram of a message for sharing channel condition information.

FIG. 9 depicts a flowchart for a root AP assisting with enhanced channel selection.

FIG. 10 depicts a flowchart for sharing channel condition information.

FIG. 11 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The examples in this disclosure are based on wireless local area network (WLAN) communication according to the Institute of Electrical and Electronics Engineers (IEEE) 802.11 wireless standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In this disclosure, a network may be referred to as a wireless local area network (WLAN) when the network includes one or more access points (APs). An AP may provide a wireless coverage area for devices to access the WLAN via a wireless channel. In some implementations, a network (such as a local area network in a home, apartment, business, or other area) may include multiple APs. Furthermore, each AP may have different hardware capabilities (e.g., 2.4 GHz and/or 5 GHz support, dual band single radio, dual band dual concurrent radios (DBDC), etc.) that may provide different options for wireless coverage. Typically, each AP will utilize one or more channels within a frequency band. A channel may refer to a frequency (or range) used by the AP to communicate with devices that have a wireless association with the AP. Similarly, the devices utilize the channel to communicate with the AP. Devices in the network can establish a wireless association (also referred to as a wireless link, wireless connection, or the like) via the channel configuration of an AP to access the WLAN. The AP, the wireless channel configuration, and the set of devices that are wirelessly associated with the AP are referred to as a Basic Service Set (BSS).

Channel selection refers to a mechanism for an AP to select a channel for a BSS in a wireless coverage area. In this document, a channel selection may refer to an initial channel selection (when first introducing an AP into a network) or a channel reselection (when updating or switching channels used by an existing AP in the network). An AP may support one or more frequency bands, and each frequency band may define multiple channels. In some implementations, channel selection may include selection of a frequency band in addition to the channel within the frequency band. In a network having multiple APs, some APs may create overlapping wireless coverage areas using different channels. It may be possible for multiple APs to use the same channel in overlapping wireless coverage areas using channel reuse. Channel reuse refers to the ability for a first and second AP to utilize the same channel when the co-channel interference between the first and second AP is sufficiently low. For example, channel reuse allows both the first and second AP to utilize the channel with acceptable amounts co-channel interference.

Traditional channel selection techniques rely only on channel conditions that are directly observable by an AP. For example, an AP may observe channel conditions by scanning available channels and detecting communications or signal strengths of other devices or APs that are utilizing the channel. A traditional AP may consider the signal strengths of the signals that it receives from nearby APs. However, absent more information, relying on only the signal strengths of nearby APs could lead to a distorted understanding of the network when multiple APs are present. For example, an AP may be unaware of the topology of the network in which one or more APs may be organized in various configurations (such as a multi-hop wireless path or a mesh topology). An AP may perform a channel selection that adversely impacts another AP in the topology. Thus, one channel selection at a first AP may cause a chain reaction causing multiple APs to reselect new channels. It is desirable to utilize a distributed channel selection technique that can be performed by each AP, while still supporting some coordination among multiple APs in the network.

In accordance with this disclosure, an enhanced channel selection technique may combine aspects of a distributed channel selection algorithm with centralized supervision. The enhanced channel selection technique may optimize the overall performance of a network having multiple APs. This disclosure provides several tools to enhance channel selection by a first AP in coordination with a Multi-AP Controller. A Multi-AP Controller (sometimes referred to as a root AP, or RAP) is a logical entity that implements logic for controlling the operation of a network having multiple APs. A Multi-AP controller may or may not provide a wireless coverage area itself. For brevity, some examples of this description refer to a root AP (or RAP) which serves as the Multi-AP Controller and also provides wireless coverage. However, in some implementations, a Multi-AP Controller may not provide wireless connectivity and may be communicatively coupled to one or more APs in the network. The Multi-AP Controller may implement protocols for communicating with one or more APs in the network to coordinate an enhanced channel selection technique. The enhanced channel selection technique may aid in the automated configuration, optimization, and management of APs in a network (such as a self-organizing network, SON). For example, using enhanced channel selection, each AP in a network may dynamically select an optimal channel for the AP, while optimizing overall capacity of the network.

In one aspect of this disclosure, channel selection may be enhanced by coordinating channel selection by combining a first channel selection process at a first AP (based on channel condition information) with a second channel selection process at a root AP or Multi-AP Controller (based on considerations of the overall network). For example, the instructions may cause the first AP to perform a channel evaluation to generate a first list of channels (which may be referred to as a list of “preferred” channels). The root AP may evaluate the candidate channels in the first list of channels and select a subset of the first list of channels to generate a second list of channels. The second list of channels may be a reduced/revised list of the channels selected by the first AP. Because both the first AP and root AP have evaluated the channels, the resulting subset of channels are deemed acceptable based on the local channel conditions of the first AP and the overall network considerations (“big-picture”) of the root AP.

In one aspect of this disclosure, channel selection can be enhanced by utilizing additional channel condition information during the channel selection process. For example, in addition to channel conditions detected by the first AP, a first AP may obtain channel condition information conveyed in a message from a second AP or the root AP. The channel condition information may include information not otherwise available to the first AP by observing wireless signals detectable by the first AP.

In another aspect of this disclosure, the instructions may cause the first AP to use the channel condition information to better estimate the impact of selecting a particular candidate channel. For example, the instructions may cause the first AP to determine a more accurate estimate of the effective channel capacity for the candidate channel. The first AP also may determine the load impact to another AP that would result from the first AP utilizing the candidate channel.

In another aspect of this disclosure, the instructions may cause the first AP to determine the probability that a local channel selection will trigger a channel selection by a second AP. For example, the instructions may cause the first AP to determine a remote channel switch trigger condition associated with the second AP. The instructions may cause the first AP to estimate a resulting channel condition at the second AP that would result from the first AP selecting the candidate channel. The probability of triggering the remote channel switch trigger condition may be based on the estimated resulting channel condition.

In another aspect of this disclosure, the enhanced channel selection may inherently increase stability of the network due to the coordination of optimal channel selection by a first AP and root AP. Furthermore, the enhanced channel selection may include tools to increase stability of the network. In some implementations, the enhanced channel selection may be limited to prevent simultaneous channel selection by more than one neighboring AP. The enhanced channel selection may be coordinated by a root AP to manage the overall network and/or to prevent changes that would result in a chain reaction (or cascade) of subsequent channel selections.

Particular implementations of the subject matter described in this disclosure can be implemented to realize one or more of the following potential advantages. The enhanced channel selection enables a first AP to identify its preferred operating channels based on the information it collects to maximize the network capacity from its local perspective as well as allowing the root AP to coordinate the channels based on a global view of the network. Thus, the overall capacity and performance of the network may be optimized.

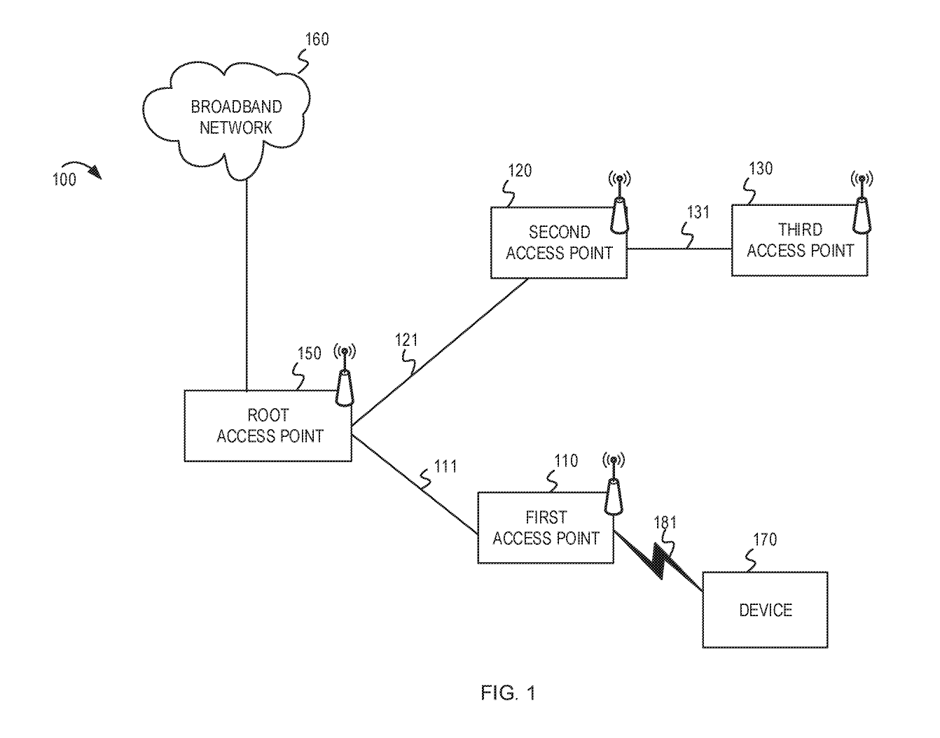

FIG. 1 depicts a system diagram of an example network with multiple access points (APs). The network 100 includes a root access point (root AP, or RAP) 150 that serves as a Multi-AP Controller for the network 100. In FIG. 1, the RAP 150 also provides access to a broadband network 160. For example, the RAP 150 may be a central access point or router which is communicatively coupled to the broadband network 160. The root AP 150 may be separate or collocated with a gateway device (not shown). A gateway device, such as a modem or router, may provide access to the broadband network 160. For example, the gateway device can couple to the broadband network through a cable, a fiber optic, a powerline, or DSL network connection. The network also includes multiple APs, including a first a first AP 110, a second AP 120, and a third AP 130. Devices in the network can establish a wireless association (also referred to as a wireless link, wireless connection, or the like) with an AP to access the broadband network via the gateway device. For example, the wireless association may be in accordance with an association protocol associated with the wireless coverage area of the AP. In some implementations (as shown in FIG. 1), the root AP 150 is independent and separate from the multiple APs. In other implementations, one of the multiple APs may be collocated with the root AP 150 or may be part of the same apparatus. In this disclosure, the term AP refers to any device that provides wireless access to a network, including access points and range extenders.

The first AP 110 may have a backhaul channel 111 to the root AP 150. The second AP 120 may have a backhaul channel 121 to the root AP 150. The third AP 130 may have a backhaul channel 131 to the second AP 120. In some examples, the backhaul channels may form a multi-hop path involving more than one AP that are wirelessly connected to each other (such as a chain) and to the RAP 150. For example, the second AP 120 and the third AP 130 may provide a multi-hop path from a client device (not shown) of the third AP 130 to the RAP 150. In this arrangement, the third AP 130 may be referred to as a child AP of the second AP 120. Similarly, the second AP 120 and first AP 110 may be referred to as child APs of the root AP 150. A child AP (also referred to as a satellite AP, or SAP) is any access point that receives network access to the broadband network 160 via one or more upstream APs. For example, as shown in FIG. 1, the third AP 130 obtains access to the broadband network 160 via the second AP 120 and root AP 150. A child AP will utilize a backhaul channel to access an upstream AP. The backhaul channels 111, 121, 131 may be wired and/or wireless.

The network 100 includes a device 170 (e.g., a laptop, a computer, a sensor, a camera, a thermostat, a mobile station, a wireless device, a smartphone, etc.) that is initially associated (shown as wireless association 181) with the first AP 110. In the example in FIG. 1, the device 170 may be a wireless station (STA). In other examples, the device 170 may be a child AP that has wireless associations with other STAs. Although FIG. 1 only depicts on device (device 170) accessing a wireless channel utilized by the APs 110, 120, and 130.

In some implementations, the APs 110, 120, and 130 can be configured as a dual band, dual concurrent (DBDC) wireless device. A DBDC device can include two transceivers and can operate on two different frequency bands independently and simultaneously. For example, a first transceiver can operate in the 2.4 GHz frequency band and a second transceiver can operate in the 5 GHz frequency band. The two transceivers can be linked within the DBDC device such that data can be communicated between the transceivers. When using DBDC devices, additional network data pathway selections are possible. Furthermore, in some implementations, a network (such as a hybrid network) can support both wired and wireless communication technologies, multiple wired communication technologies, or multiple wireless communication technologies. For example, the root AP and/or the APs 110, 120, and 130 can support both IEEE 802.11 and powerline communication protocols. In other examples, the root AP and/or the APs 110, 120, and 130 can support a combination of IEEE 802.11 and powerline communication protocols, a combination of IEEE 802.11 and coaxial cable (Coax) based communication protocols, a combination of long-term evolution (LTE) and IEEE 802.11 communication protocols, a combination of IEEE 802.11 and Bluetooth communication protocols, and various other suitable combinations. Thus, the network data pathways in the hybrid network can include wired and wireless communication technologies. In some implementations, the root AP 150 and the APs 110, 120, and 130 can comply with other wireless specifications, such as a ZigBee® specification, or a cellular radio specification or any other technically feasible wireless protocol. The link between the root AP 150 and the broadband network 160 can be referred to as a broadband link. The broadband link can provide at least a portion of a data pathway to another network (e.g., communication service provider network, Internet, etc.). The broadband link of the root AP 150 can be a wireless, a wired (such as through an Ethernet or powerline connection), or a hybrid link. The enhanced channel selection in this disclosure can be used with DBDC wireless devices similarly as with non-DBDC wireless devices. While most implementations in this disclosure are described in relation to one channel per device (such as, the root AP 150 and the APs 110, 120, and 130), the implementations are not so limited. Each of the root AP 150 and the APs 110, 120, and 130 may use the enhanced channel selection to select more than one channel to be used for more than one transceiver, respectively. The enhanced channel selection may be performed iteratively or concurrently (by replicating the techniques in this disclosure) for an AP that supports more than one channel (such as a DBDC device). The enhanced channel selection technique is described further below. In accordance with this disclosure, the enhanced channel selection technique may be performed using coordination among multiple APs or between an AP and a root AP (Multi-AP Controller). The enhanced channel selection technique may improve the overall performance of the network by taking into account the topology of a multi-hop network and overlapping wireless coverage areas.

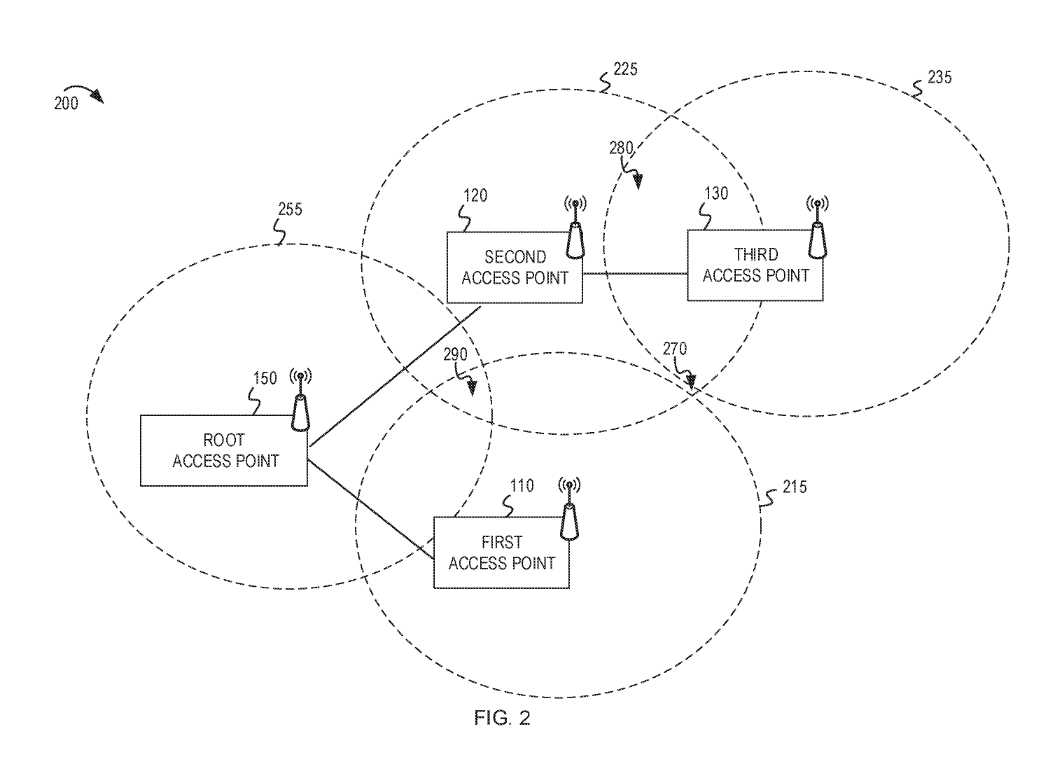

FIG. 2 depicts another system diagram showing wireless coverage areas of the multiple APs. The network 200 provides more detail regarding network 100 described in FIG. 1. The device 170 and broadband network 160 are omitted from network 200 for brevity. Each of the APs 110, 120, and 130 (and the root AP 150) may provide a wireless coverage area. A wireless coverage area refers to a physical area in which an AP can transmit and receive signals on a channel. An AP may not provide uniform coverage within an environment. As the wireless signals propagate further from the AP, wireless signal strength decreases. The wireless coverage may be a factor of the signal power, device capabilities, AP capabilities, frequency propagation, materials, and/or radio frequency (RF) interference. Therefore, a wireless coverage area may not be a precise distance from an AP. Furthermore, different channels may be associated with different wireless coverage areas based on the environment or other APs in the network. Therefore, enhanced channel selection may result in an optimal channel for maximizing the combined coverage areas of multiple APs in the network.

Shown in FIG. 2, the root AP 150 provides a root wireless coverage area 255; the first AP 110 provides a first wireless coverage area 215; the second AP 120 provides a second wireless coverage area 225; and the third AP 130 provides a third wireless coverage area 235. The wireless coverage areas may overlap. For example, the second wireless coverage area 225 and third wireless coverage area 235 are shown with an overlapping coverage area at 280. Ideally, a different channel would be used for the second wireless coverage area 225 than a channel used for the third wireless coverage area 235. By selecting different channels for overlapping coverage areas, the effective channel capacity for each of the different channels is not affected (or only minimally affected) by the overlapping coverage area.

Shown at 270, there may be non-overlapping coverage areas (such as the first wireless coverage area 215 and third wireless coverage area 235) in the vicinity of overlapping coverage areas (such as the second wireless coverage area 225 and the third wireless coverage area 235). In another example, at 290, there are three overlapping coverage areas (the root wireless coverage area 255, the first wireless coverage area 215, and the second wireless coverage area 225). In an optimal channel selection algorithm, there would be no channel reuse for overlapping coverage areas. However, sometimes it is unavoidable to reuse a same channel for an overlapping coverage area. For example, when multiple APs in the network operate in proximity to each other. Furthermore, it may be desirable for some homes, apartments, buildings, or other environments to utilize many APs to provide wireless coverage throughout the environment.

As described earlier, each AP may be capable of scanning for a set of channels within a frequency band. However, without considering the impact of channel selection with respect to other APs, a channel selection at one AP may inadvertently impact another AP. For example, using a traditional channel selection technique, the first AP 110 may select a channel for first wireless coverage area 215 based on what the first AP 110 can observe (such as root wireless coverage area 255). However, the first AP 110 may inadvertently select a channel that impacts the second wireless coverage area 225 or the third wireless coverage area 235 (possibly unbeknownst to the first AP 110).

For example, a channel selected by the first AP 110 may appear to be unutilized (or underutilized) in a wireless scan performed by the first AP 110. However, the same channel may appear to be heavily loaded (or significant interference) at the second AP 120 (possibly from a different network that is also operating within a coverage area of the second AP 120). The second AP 120 can be impacted in multiple ways depending on how it is utilizing its radios. For example, if the second AP 120 is using that channel for a backhaul channel from the second AP 120 to the first AP 110, then the second AP 120 may see higher packet errors for the backhaul channel due to a neighboring interferer that is unseen by the first AP 110. In another example, if the second AP 120 is using the channel for both backhaul and BSS service links, then the second AP 120 also may be constrained in the amount of traffic it can serve in its BSS (since the second AP 120 would be contending with the neighbor AP, even though the neighbor AP is unseen by the first AP 110).

Thus, when selecting a channel, the first AP 110 may benefit from obtaining channel condition information that is observable by other APs in the network (even if some of the channel conditions are not directly observable by the first AP 110). Furthermore, by coordinating enhanced channel selection between the first AP 110 and the root AP 150 (Multi-AP Controller), the root AP 150 may select a better channel to maximize channel reuse within the network, such as when overlapping coverage areas are unavoidable. Maximizing channel reuse may improve the overall network capacity.

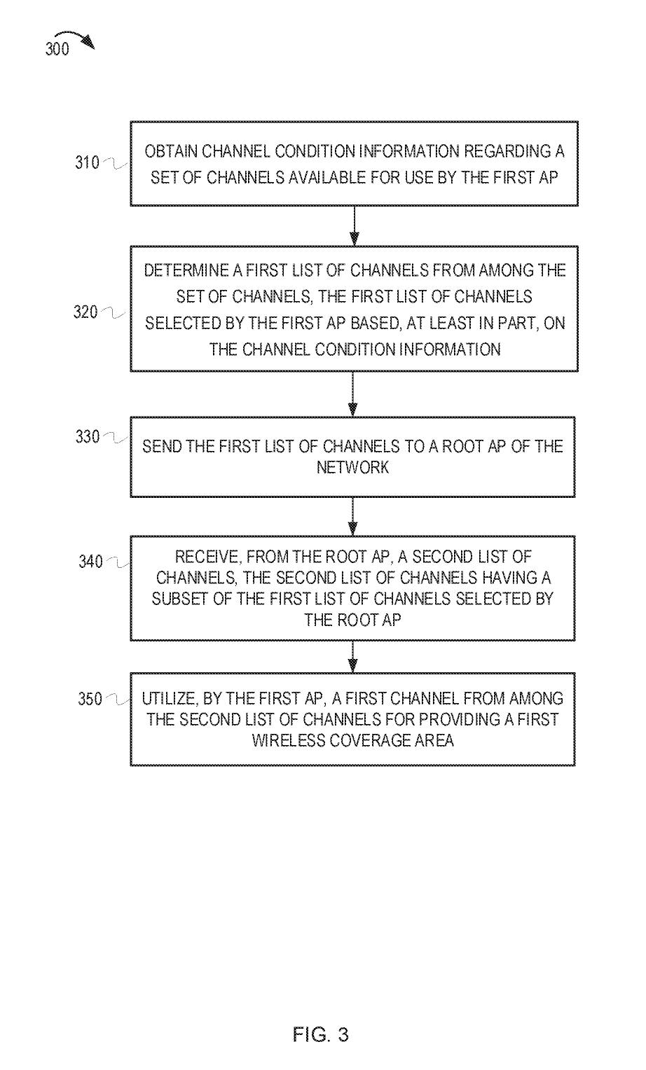

FIG. 3 depicts a flowchart of a first AP performing an enhanced channel selection. The flowchart 300 begins at block 310.

At block 310, the instructions may cause the first AP to obtain channel condition information regarding a set of channels available for use by the first AP. For example, the instructions may cause the first AP to scan the set of channels, and determine the channel condition information based on what is observable by the first AP scanning the set of channels. Alternatively, or additionally, the instructions may cause the first AP to send a query message to at least a second AP (and possibly one or more other APs) in the network, and receive a response message from the second AP (and possibly the one or more other APs). The response message may have at least a portion of the channel condition information. In some implementations, the instructions may cause the first AP to send a query message to the root AP in the network, and receive a response message from the root AP. The response message from the root AP may have the channel condition information regarding the second AP (and possibly the one or more other APs). In some implementations, the channel condition information comprises first information about a second channel used by the second AP and second information about other channels detected by the second AP.

At block 320, the instructions may cause the first AP to determine a first list of channels from among the set of channels, the first list of channels selected by the first AP based, at least in part, on the channel condition information. For example, the instructions may cause the first AP to rank the set of channels based, at least in part, on the channel condition information, and select the first list of channels from the ranking. The first list of channels may be determined by comparing an effective channel capacity for each candidate channel. Other considerations may be used by the first AP. For example, the instructions may cause the first AP to consider an estimated load impact to a neighbor AP that is already using the candidate channel or a probability of triggering a remote channel switch trigger condition of the neighbor AP that would result from the first AP selecting the candidate channel. In some implementations, the instructions may cause the first AP to generate a score for each candidate channel based on the effective channel capacity, estimated load impact, and/or probability of triggering a remote channel switch trigger condition. The scores for a plurality of candidate channels may be used to rank or order the candidate channels. In some implementations, the first list of channels includes the higher ranked channels from the plurality of candidate channels (such as a number n of the highest ranked channels).

In some implementations, the enhanced channel selection also may be used to determine a channel size within a frequency band that supports different channel sizes. For example, the instructions may cause the first AP to be capable of utilizing either of a 20 MHz, 40 MHz, 80 MHz, or other channel size within a frequency band (such as the 5.0 GHz frequency band defined in the IEEE 802.11 standards). The first list of channels may include a ranked (in order of preference) listing of channels even though the channels in the list may be of different channel sizes.

At block 330, the instructions may cause the first AP to send the first list of channels to a root AP of the network. The root AP may distill the first list of channels based on considering how each candidate channel in the first list would impact the overall network performance. For example, the root AP may utilize a contention graph coloring algorithm to maximize channel reuse in the network.

At block 340, the instructions may cause the first AP to receive, from the root AP, a second list of channels, the second list of channels having a subset of the first list of channels selected by the root AP.

At block 350, the instructions may cause the first AP to utilize, by the first AP, a first channel from among the second list of channels for providing a first wireless coverage area. For example, the instructions may cause the first AP to select, from the second list of channels, a new channel and switch the wireless coverage area of the first AP to the new channel. The instructions may cause the first AP to configure the BSS to utilize the new channel.

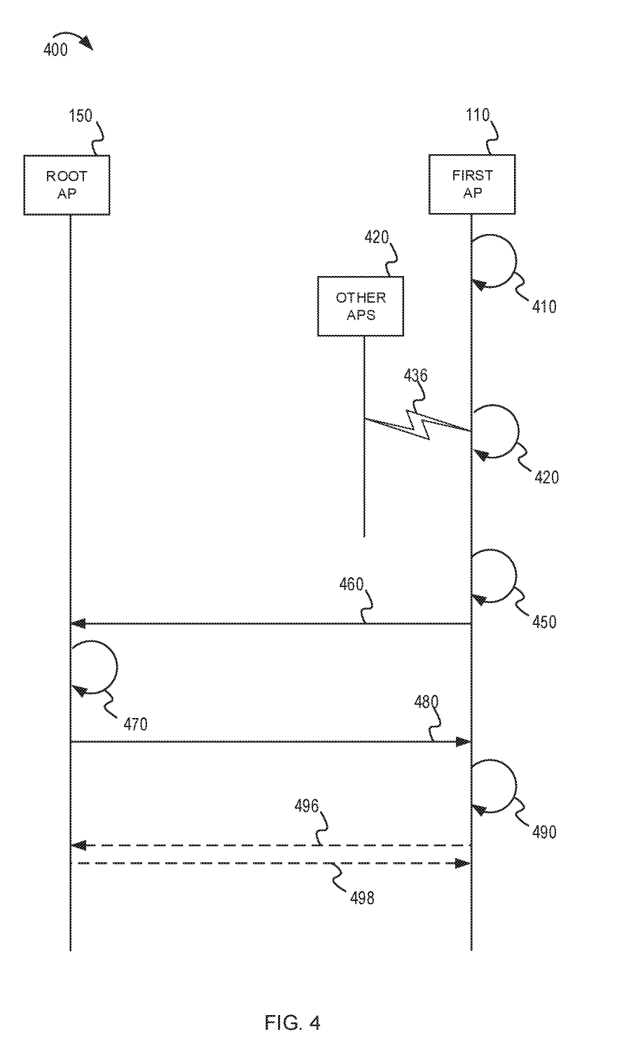

FIG. 4 depicts a message flow diagram of example implementation of enhanced channel selection. The message flow diagram 400 describes messages between the first AP 110 and root AP 150. At 410, the first AP 110 may detect a local channel switch trigger condition. A channel switch trigger condition may be any condition which triggers the first AP 110 to perform a channel evaluation for the enhanced channel selection. For example, the first AP 110 may receive a channel switch trigger message from the root AP or another AP in the network. In another example, the local channel switch trigger condition may be a locally (at the first AP) initiated channel evaluation. In some implementations, the local channel switch trigger condition may be previously configured by the root AP 150. For example, the root AP 150 may send parameters (such as conditions or thresholds) to be used by the first AP 110 for the local channel switch trigger condition.

Examples of a local channel switch trigger condition may include:
determining a deterioration of the channel condition for a current channel used by the first AP
determining that the first AP has a load higher than a trigger threshold
determining co-channel interference on a current channel being used by the first AP, where the co-channel interference is impacting channel availability for one or more stations associated with the current channel
comparing an interference power level with a threshold level
comparing a current time with a trigger time configured at the first AP

At 420, the first AP 110 may scan (shown as 436) the set of channels to obtain whatever channel condition information can be observed by scanning the channels. Scanning may include observing signals from other devices or other APs 420 that may be using the channels. Scanning may be used to determine channel signal strength and/or current utilization of the channel.

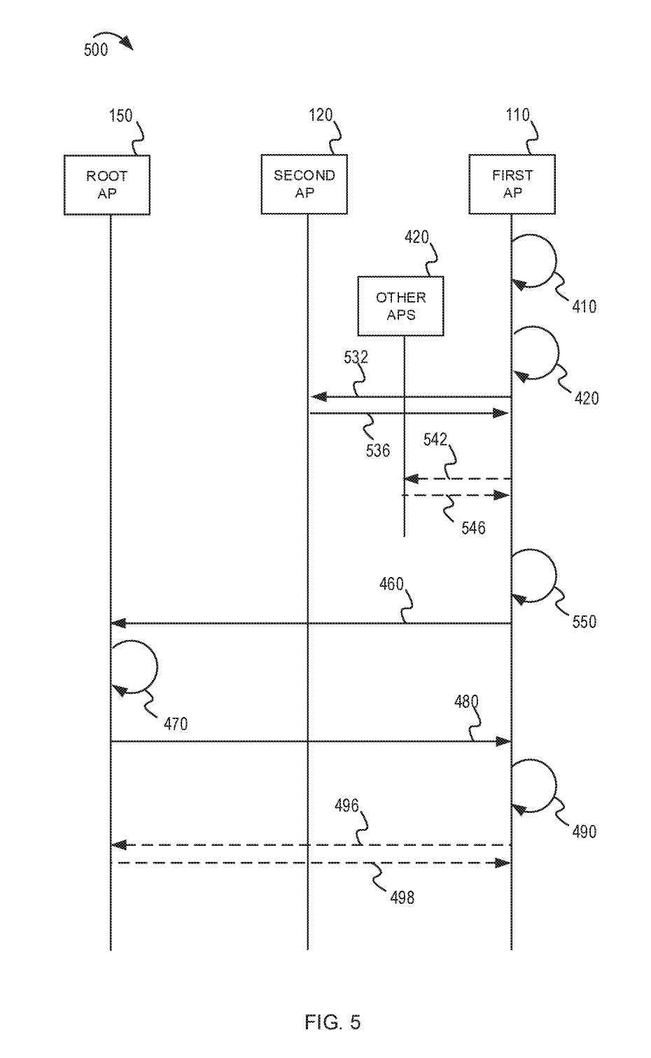

At 450, the first AP 110 may determine a first list of channels using a first selection algorithm at the first AP 110. For example, the first AP 110 may determine the first list of channels based on ranking an effective channel capacity for each channel. The effective channel capacity may be estimated using parameters such as the available airtime of a channel, overlapping BSS airtime, number of devices in the overlapping BSS, signal strength, interference power level, and the physical data rate for devices of the first AP's BSS. The first list of channels may be selected in consideration of a load impact on the other APs 420 if the first AP chooses a channel being used by the other APs 420. In another example, the probability of triggering a neighbor AP to switch channels may be considered when selecting the first list of channels (described further in FIG. 5).

In some implementations, the first AP 110 may consider a candidate channel that is already utilized by one or more neighbor APs. For example, a BSS of a neighbor AP may be considered an overlapping BSS (OBSS) if a least part of the coverage area for the neighbor AP is overlapping the coverage area of the first AP 110. The first AP 110 may determine the effective channel capacity as an estimate of how much of the OBSS airtime the first AP 110 may be expected to utilize via normal airtime contention procedures. For example, in some implementations, the first AP 110 may determine a current available airtime of the candidate channel utilized by the OBSS, determine an additional contention airtime of the candidate channel based, at least in part, on a quantity of stations associated with the first AP and the current available airtime (utilized by the OBSS), determine an estimated physical layer transmission data rate for the quantity of stations associated with the first AP, and calculate the effective channel capacity based, at least in part, on the current available airtime, the additional contention airtime, and the estimated physical layer transmission rate.

At 460, the first AP 110 sends the first list of channels to the root AP 150. For example, the first AP 110 may send the first list of channels in a message (which may be referred to as a “Channel Switch Request message” or a “Channel Preference Report message”). In some implementations, the Channel Preference Report message may be sent by the first AP 110 in response to a Channel Preference Query message (not shown) from the root AP 150 to the first AP 110.

At 470, the root AP 150 may distill the first list of channels to determine a second list of channels, which is a subset of the first list of channels. For example, the root AP 150 can reduce/revise the first list of channels based on the root AP's global consideration of the network. In some implementations, the root AP 150 can compare the first list of channels to its own assessment of best channel allocation based on channel condition information collected by the root AP 150. The root AP 150 also may consider the channel reuse opportunities in the network. For example, the root AP 150 may use a contention graph coloring algorithm to allocate channels so as to maximize channel reuse while using the preferred channels recommended by each of the APs in the network. Examples of the contention graph coloring algorithm may include maximizing channel reuse based on a logical topology of the network, a physical topology of the network, a channel constraint for at least one AP in the network, and/or channel condition information from more than one AP in the network.

At 480, the root AP 150 sends the second list of channels to the first AP 110. For example, the second list of channels may be included in a message (which may be referred to as a “Channel Switch Response message” or a “Channel Selection Request message”) to the first AP 110. For example, after receiving the Channel Preference Report message from the first AP 110, the root AP 150 may send a Channel Selection Request message back to the first AP 110 to provide the second list of channels which were prepared by the root AP 150.

In some implementations, the messages at 460 and 480 also may be used to communicate priorities or selection criteria. For example, each channel indicated in the messages may be associated with a preference score that can be used for ranking or ordering the channels in a channel selection algorithm. If a channel is non-operable (meaning it cannot be or should not be selected), the channel may have a preference score of zero (“0”). Otherwise, each channel may be associated with a preference score in a range (such as from 1-15).

In some implementations, the messages at 460 and 480 also may be used to communicate channel constraints. For example, in addition to a first list of channels (indicating preferred channels), the message at 460 also may include a list of constrained channels (indicating blocked channels that the first AP 110 should not use). The list of constrained channels may include channels (or channel sizes within a frequency band) that should be avoided by the first AP 110. In one example, the list of constrained channels may be included to assist the root AP 150 in allocating channels in the contention graph coloring algorithm. Similarly, the response message at 470 may include a list of constrained channels which the root AP 150 forbids or restricts the first AP 110 from selecting. In some implementations, the message at 460 may include a listing of concurrent channels that are being used by the first AP 110. For example, if the first AP 110 is capable of operating on more than one channel (such as a DBDC device, or any device with more than one transceiver), the listing of concurrent channels may inform the root AP 150 of the other channels being utilized by the first AP 110.

At 490, the first AP 110 may select a first channel from the second list of channels and utilize the first channel for a wireless coverage area of the first AP 110. In some implementations, if the first AP 110 knows (from the channel condition information) that it will be utilizing a channel that is currently being used by a neighboring AP, the first AP 110 may inform the neighboring AP before utilizing the channel. Although it may be unavoidable for the first AP 110 to step onto the channel, informing the neighboring AP may provide the neighboring AP with notice about a potential change in the BSS channel capability before the change occurs. The neighboring AP may be in a position to mitigate some of the impact expected from the first AP 110.

Optionally, at 496, the first AP 110 may send a message (which may be referred to as a “Channel Switch Finish message” or a “Channel Selection Report message”) to the root AP 150 to indicate that the first AP is utilizing the first channel. At 498, the root AP 150 may send an acknowledge message (such as a Channel Switch Finish Response message) to the first AP 110. The root AP 150 also may inform another AP (such as a neighbor AP of the first AP 110) about the channel selection of the first AP 110 (if the first AP 110 has not already done so).

FIG. 5 depicts a message flow diagram of another example implementation of enhanced channel selection using channel utilization query messages. The message flow diagram 500 includes similar messages and processes as those described in the message flow diagram 400 of FIG. 4. At 410, the first AP 110 may detect a local channel switch trigger condition. At 420, the first AP 110 may scan (shown as 436) the set of channels to obtain whatever channel condition information can be observed by scanning the channels.

Different from FIG. 4, the message flow diagram 500 includes a mechanism for the first AP 110 to obtain more channel condition information about the other APs, such as the second AP 120 and the other APs 420. At 532, the first AP 110 may send a query message (which may be referred to as a “Channel Utilization Query message” or an “AP Metrics Query message”) to the second AP 120 to obtain channel condition information from the second AP 120. The second AP 120 may send a response message (which may be referred to as a “Channel Utilization Response message” or an “AP Metrics Response message”) to the first AP 110. The response message may include more information than is included in previous Channel Utilization Response messages. For example, the Channel Utilization Response message described by IEEE 802.11 standards may be extended to include more channel condition information. As an example, the message at 536 may describe one or more channel switch trigger conditions of the second AP 120 (referred to as a remote channel switch trigger condition to distinguish from a local channel switch condition of the first AP 110). As another example, the message 536 also may describe one or more other channels observed by the second AP 120, but which the second AP 120 is not currently using. For example, the second AP 120 may include channel condition information that it has obtained by performing a channel scan at the second AP 120.

Similar to 532 and 536, the first AP 110 may send and receive other messages 542 and 546 to the other APs 420 in the network. By soliciting channel condition information from multiple APs (and particularly from neighboring APs), the first AP 110 can collect a more complete view of the network. As described below, the first AP 110 can utilize the channel condition information obtained from multiple APs to enhance a channel selection algorithm at the first AP 110.

At 550, the first AP 110 may determine a first list of channels using the channel condition information and a first selection algorithm at the first AP 110. As described for 450 in FIG. 4, the channel selection algorithm at 550 also may take into account an estimate of the probability of triggering the neighbor AP to switch channel. The first AP 110 may estimate the probability by determining the remote channel switch trigger condition of the neighbor AP, estimating a resulting channel condition at the neighbor AP that would result from the first AP selecting the candidate channel, and comparing the resulting channel condition to the remote channel switch trigger condition. The estimated resulting channel condition also may be based on the channel condition information, including:
a quantity of neighboring APs
the received signal strength indicators (RSSIs) of neighboring BSS's (including the neighboring AP and associated STAs)
a channel utilization level of the neighboring BSS (overlapping BSS)
a reported collision rate
channel access delay
interference power level

After determining the first list of channels based on the considerations at 550, the message flow diagram 500 may proceed with similar messages and processes (at 460, 470, 480, 490, 496, and 498) as described previously in FIG. 4.

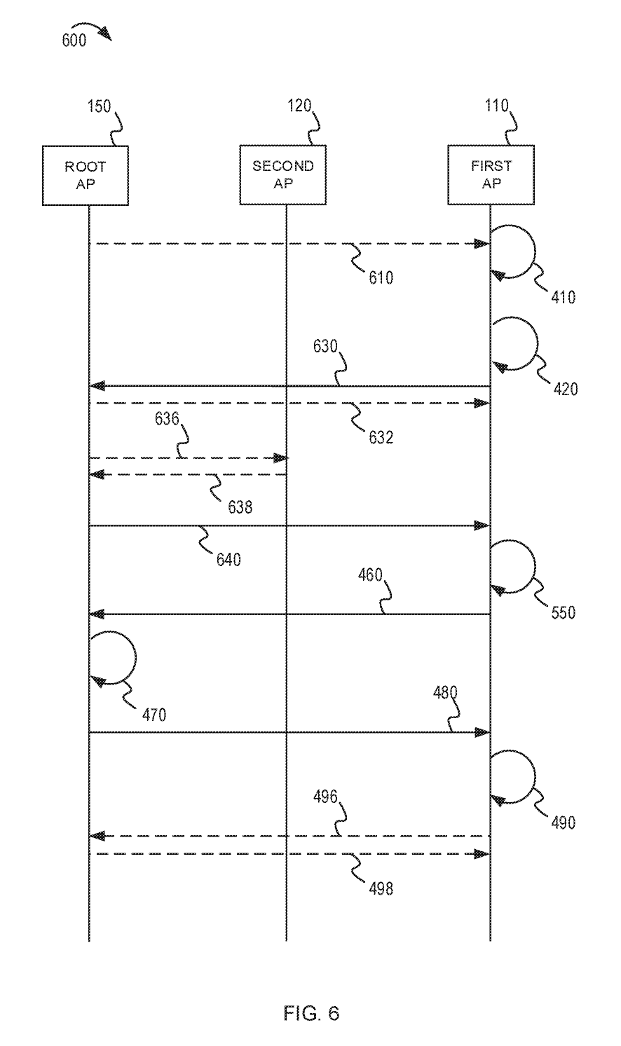

FIG. 6 depicts a message flow diagram of another example implementation of enhanced channel selection using a root AP to collect channel condition information. The message flow diagram 600 includes similar messages and processes as those described in the message flow diagram 400 of FIG. 4. At 410, the first AP 110 may detect a local channel switch trigger condition. Shown at 610, the local channel switch trigger condition may be a result of a message (such as a Channel Switch Trigger message or a Channel Switch Allowed message) from the root AP to the first AP. The message at 610 may be used by the root AP 150 to control stability of the network by forcing or preventing channel selection by a particular AP. In the example of FIG. 6, the message at 610 may prompt the channel selection by the first AP 110. At 420, the first AP 110 may scan (shown as 436) the set of channels to obtain whatever channel condition information can be observed by scanning the channels.

Different from FIGS. 4 and 5, the message flow diagram 600 includes another mechanism for the first AP 110 to obtain more channel condition information about the other APs. In the message flow diagram 600, the root AP 150 may collect the channel condition information from one or more APs in the network and provide the collected channel condition information to the first AP 110. At 630, the first AP 110 may send a request (which may be referred to as a “Neighbor BSS Channel Condition Query message” or a “Combined Infrastructure Metrics Query message”) to the root AP 150. If the root AP 150 has previously collected the requested channel condition information, the root AP 150 may send the requested channel condition information in a response (which may be referred to as a “Neighbor BSS Channel Condition Query Response message” or a “Combined Infrastructure Metrics Report message”) to the first AP 110. The response is shown at 640 in the message flow diagram 600. If the root AP 150 has not previously collected the requested channel condition information, the root AP 150 may obtain the information before sending the response 640. For example, at 632, the root AP 150 may send an acknowledgement message (such as a Neighbor BSS Channel Condition Query Hold message) to the request with an indicator to wait while the root AP 150 collects the requested channel condition information. At 636 and 638, the root AP 150 may send and receive messages (similar to 532 and 536) to obtain the channel condition information from the second AP 120. The root AP 150 also may exchange other messages (not shown) with other APs in the network. After collecting the channel condition information, the root AP 150 sends the collected channel condition information to the first AP 110 at 640. In some implementations, the collection of channel condition information may be responsive to a request (as shown in FIG. 6). In other implementations, the root AP 150 may periodically request channel condition information from the multiple APs in the network so that the information is already available to the root AP 150 when needed for a response to a request. In other implementations, the APs (such as APs 110, 120, and 130) may periodically report channel condition information to the root AP 150.

After receiving the channel condition information from the root AP 150 (at 640), the first AP 110 may proceed with the enhanced channel selection. The message flow diagram 600 may proceed with similar messages and processes (at 550, 460, 470, 480, 490, 496, and 498) as described previously in FIGS. 4 and 5.

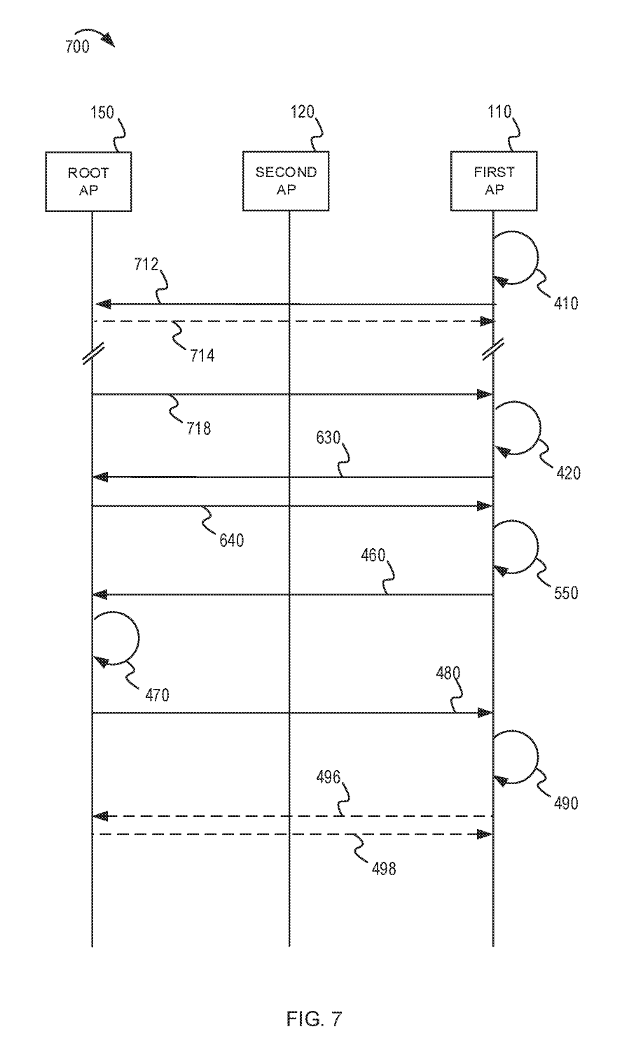

FIG. 7 depicts a message flow diagram of another example implementation in which a root AP manages enhanced channel selection. The message flow diagram 700 includes similar messages and processes as those described in FIGS. 4-6. Different from FIGS. 4-6, the message flow diagram 600 includes a mechanism for the root AP 150 to manage network stability by controlling when the first AP 110 may perform a channel selection.

At 410, the first AP 110 may detect a local channel switch trigger condition. However, before proceeding with the channel evaluation or channel selection, the first AP 110 may send a start message (such as a Channel Switch Start message) to the root AP 150, shown at 712. The start message may indicate that the first AP 110 has detected a trigger condition and is initiating a channel selection procedure. At 714, the root AP 150 may respond with a hold message (such as a Channel Switch Hold message) to cause the first AP 110 to cease or postpone the channel selection procedure. For example, the root AP 150 may be aware of another AP in the network may have previously initiated a channel switch and may cause the first AP 110 to delay its channel selection until after the other AP completes the channel switch. Thus, the hold message may prevent multiple APs from concurrently performing a channel selection or channel switch, particularly if the multiple APs may have an overlapping coverage area. There may be other reasons that the root AP 150 may send a hold message, such as to promote stability of the network during particular periods of time (such as a peak utilization time period).

At 718, the root AP 150 may send a proceed message (such as a Channel Switch Trigger message, a Channel Switch Allowed message, or a Channel Selection Request message) to the first AP 110. For example, the proceed message may indicate to the first AP 110 that the root AP 150 is instructing the first AP 110 to proceed with channel selection. Alternatively, the proceed message may indicate to the first AP 110 that the first AP 110 is allowed (at time chosen by the first AP 110) to proceed with a channel selection. In some implementations, the proceed message may be sent by the root AP 150 according to a fixed schedule (such as an off-peak time of day, or off-peak day of week). The proceed message may be sent by the root AP 150 regardless of whether the root AP 150 has previously received a request from the first AP 110 to start the channel selection.

In some implementations, the proceed message from the root AP 150 to the first AP 110 may indicate one or more channels pre-selected by the root AP 150. In this way, the root AP 150 may shortcut or speed up the channel selection process at the first AP

After receiving the proceed message from the root AP 150 (at 640), the first AP 110 may proceed with the enhanced channel selection. The message flow diagram 700 may proceed with similar messages and processes (at 420, 630, 640, 550, 460, 470, 480, 490, 496, and 498) as described previously in FIGS. 4-6.

Having described the various implementations in FIGS. 4-7, it is noted that further implementations may be possible within the scope of this description. For example, the enhanced channel selection techniques in this description may be modified to use one or more stability control techniques. For example, in some implementations, hysteresis can be used with any comparisons, including the comparisons used to generate the first list of channels, the second list of channels, and/or the channel condition information. In some implementations, a first AP may identify a stability condition associated with one or more neighboring APs and constrain the first list of channels subject to the stability condition of the one or more neighboring APs. In some implementations, a channel selection schedule may be used by one or more APs in the network to stagger channel selection and prevent ping ponging the channel selection by neighboring APs. In some implementations, a counter or timer can be used to limit the performance of a channel selection by a first AP. For example, the counter or timer may prevent the excessive repetition of channel selection within a time period. In some implementations, a first AP and second AP may exchange results of a channel selection, and augment the future selections (for the first list of channels) based on the previous result in addition to, or in lieu of, the channel evaluation process.

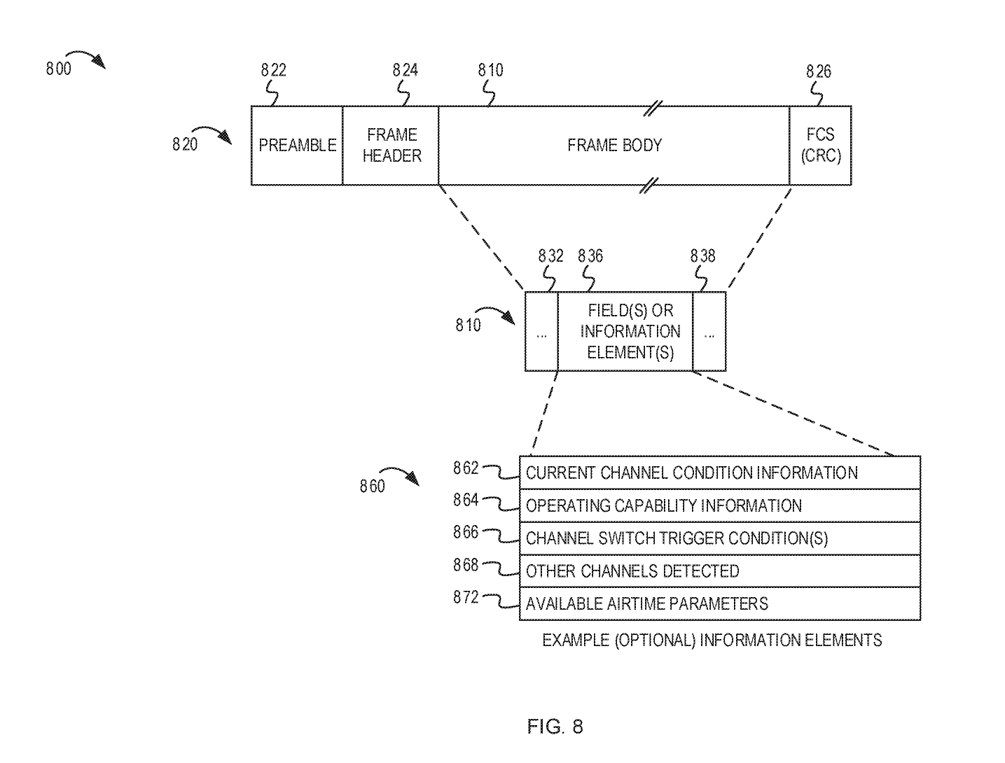

FIG. 8 depicts an example conceptual diagram of a message for sharing channel condition information. For example, the message may be sent from one AP (including the root AP) to another AP. The message may be sent from an AP to a Multi-AP Controller, or vice versa. In some implementations, the message may be a type-length-value (TLV) formatted message. FIG. 8 includes an example data frame 820. The data frame 820 may include a preamble 822, a frame header 824, a frame body 810, and a frame check sequence (FCS) 826. The preamble 822 may include one or more bits to establish synchronization. The frame header 824 may include source and destination network addresses (such as the network address of the sending AP and receiving AP, respectively), the length of data frame, or other frame control information. The frame body 810 may be organized with a message format and may include a variety of fields or information elements 832, 836, and 838.

Various fields or information elements may be used to share channel conditions information regarding a described AP. Several examples of information elements 860 are illustrated in FIG. 8. For example, the information elements may include channel current channel condition information 862 (such as channel utilization, number of STAs, contention statistics, channel availability, and the like) for one or more channels being used by the described AP. The information elements may include operating capability information 864 (such as PHY capability, MU-MIMO/OFDMA capability, un-usable channels, TX power difference in different channels, RTS/CTS, Integrated Bluetooth coexistence capability, and the like). The information elements may include one or more channel switch trigger condition(s) 866 of the described AP. The information elements may include other channels detected 868 by the described AP (such as information obtained by the AP performing a channel scan). The information elements may include available airtime parameters 872 (such as contention statistics for an overlapping BSS, PHY data rates of STS associated with the reporting BSS, interference power level, RSSIs, and the like). The airtime parameters 872 also may include information about channel access delay, collision rate, or any other information which may be usable by a first AP to estimate the effective channel capacity of a channel.

In some implementations, an AP may be equipped with more than one radio and may be capable of operating on more than one channel (such as a DBDC device). Each radio, channel, and associated STAs may be considered a separate BSS. In this situation, the AP may send multiple messages, or may send a single message having a collection of the above-described fields or information elements, to describe the multiple BSSs of the AP.

As described above, the frame body 810 may include a variety of fields or information elements related to channel selection preferences. For example, the fields or information elements may include a channel list. For each channel in the list, the message may indicate a preference score (such as a range from 1-15). The preference score may be set to zero (0) if the channel is non-operable and should not or cannot be used by the AP. In some implementations, a reason code may be included for each preference score. The reason code may indicate the reason for the preference score associated with a channel in the channel list. Some example reason codes are provided below:
0000: Unspecified
0001: Proximate non-802.11 interferer in local environment
0010: Intra-network 802.11 OBSS interference management
0011: External network 802.11 OBSS interference management
0100: Reduced coverage (such as due to limited transmit power)
0101: Reduced throughput (such as due to limited channel bandwidth of the operating class, or high channel utilization measured on the channel)
0110: In-device Interferer within AP
0111: Operation disallowed due to radar detection on a dynamic frequency selection (DFS) channel
1000: Operation would prevent backhaul operation using shared radio
1001: Immediate operation possible on a DFS channel-channel availability check (CAC) has been run and is still valid and channel has been cleared for use
1010: DFS channel state unknown (CAC has not run or its validity period has expired)

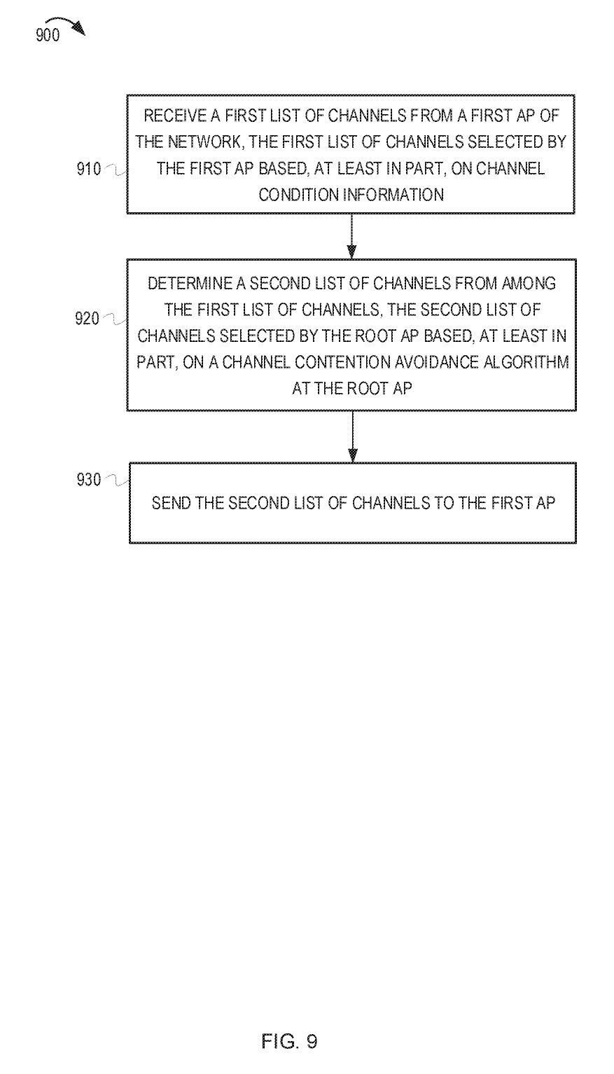

FIG. 9 depicts a flowchart for a root AP assisting with enhanced channel selection. The flowchart 900 begins at block 910. At block 910, the root AP may receive a first list of channels from a first AP of the network, the first list of channels selected by the first AP based, at least in part, on channel condition information.

At block 920, the root AP may determine a second list of channels from among the first list of channels, the second list of channels selected by the root AP based, at least in part, on a channel contention avoidance algorithm at the root AP. For example, the root AP may use a contention graph coloring algorithm to estimate the impact to the network that would result from the first AP selecting a first channel of the first list of channels. The contention graph coloring algorithm may be used to maximize channel reuse in the network. In some implementations, the contention graph coloring algorithm takes into consideration a logical topology of the network, a physical topology of the network, a channel constraint for at least one AP in the network, or channel condition information from more than one AP in the network. The second list of channels may be a subset (or reduced or revised) selection of channels from the first list of channels. At block 930, the root AP may send the second list of channels to the first AP.

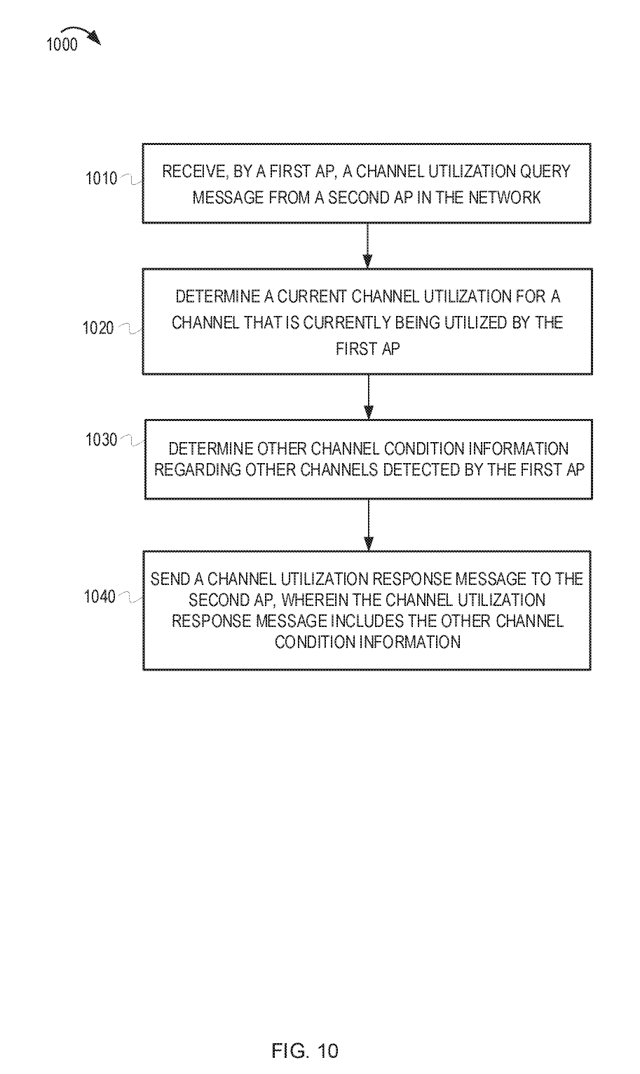

FIG. 10 depicts a flowchart for sharing channel condition information. The flowchart 1000 begins at block 1010. At block 1010, a first AP may receive a channel utilization query message from a second AP in the network. At block 1020, the instructions may cause the first AP to determine a current channel utilization for a channel that is currently being utilized by the first AP. At block 1030, the instructions may cause the first AP to determine other channel condition information regarding other channels detected by the first AP. At block 1050, the instructions may cause the first AP to send a channel utilization response message (such as the message described in FIG. 8) to the second AP, wherein the channel utilization response message includes the other channel condition information.

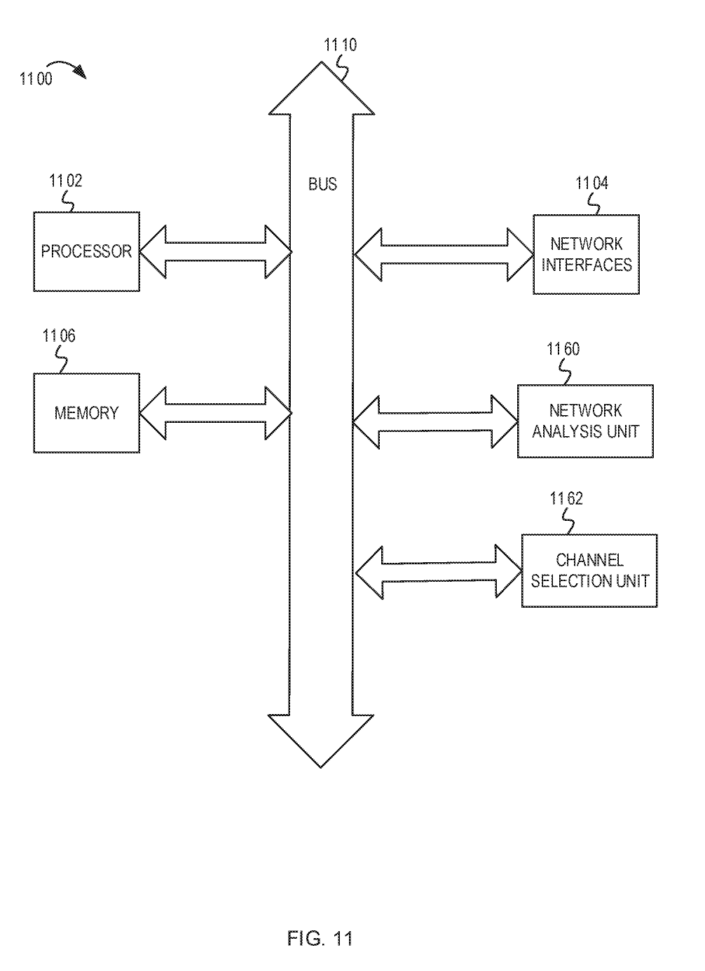

FIG. 11 shows a block diagram of an example electronic device for implementing aspects of this disclosure. In some implementations, the electronic device 1100 may be one of an access point (including any of the APs described herein), a range extender, or other electronic systems. The electronic device 1100 can include a processor unit 1102 (possibly including multiple processors, multiple cores, multiple nodes, and/or implementing multi-threading, etc.). The electronic device 1100 also can include a memory unit 1106. The memory unit 1106 may be system memory or any one or more of the below described possible realizations of computer-readable media. The electronic device 1100 also can include a bus 1110 (e.g., PCI, ISA, PCI-Express, HyperTransport®, InfiniBand®, NuBus, AHB, AXI, etc.), and a network interface unit 1104 that can include at least one of a wireless network interface (e.g., a WLAN interface, a Bluetooth® interface, a WiMAX interface, a ZigBee® interface, a Wireless USB interface, etc.) and a wired network interface (e.g., an Ethernet interface, a powerline communication interface, etc.). In some implementations, the electronic device 1100 may support multiple network interfaces—each of which is configured to couple the electronic device 1100 to a different communication network.

The electronic device 1100 may include a network analysis unit 1160 and a channel selection unit 1162. In some implementations, the network analysis unit 1160 and the channel selection unit 1162, can be distributed within the processor unit 1102, the memory unit 1106, and the bus 1110. The network analysis unit 1160 and channel selection unit 1162 can perform some or all of the operations described in FIGS. 1-10 above. The network analysis unit 1160 can determine channel condition information regarding other APs in the network. The channel selection unit 1162 can perform an enhanced channel selection using the channel condition information obtained by the network analysis unit 1160.

The memory unit 1106 can include computer instructions executable by the processor unit 1102 to implement the functionality of the implementations described in FIGS. 1-10 above. Any one of these functionalities may be partially (or entirely) implemented in hardware and/or on the processor unit 1102. For example, the functionality may be implemented with an application specific integrated circuit, in logic implemented in the processor unit 1102, in a co-processor on a peripheral device or card, etc. Further, realizations may include fewer or additional components not illustrated in FIG. 11 (e.g., video cards, audio cards, additional network interfaces, peripheral devices, etc.). The processor unit 1102, the memory unit 1106, the network interface unit 1104, and the network configurator unit 1108 are coupled to the bus 1110. Although illustrated as being coupled to the bus 1110, the memory unit 1106 may be coupled to the processor unit 1102.

FIGS. 1-11 and the operations described herein are examples meant to aid in understanding example implementations and should not be used to limit the potential implementations or limit scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A first access point (AP) for use in a network, comprising:
a processor; and
memory having instructions stored therein which, when executed by the processor cause the first AP to:
send a first list of channels to a Multi-AP Controller of the network, the first list of channels including channel selection information determined by the first AP,
receive, from the Multi-AP Controller, a second list of channels selected by the Multi-AP Controller, wherein the second list of channels is based, at least in part, on the first list of channels, and
utilize, by the first AP, a first channel from among the second list of channels for providing a first wireless coverage area.

2. The first AP of claim 1, wherein the instructions to send the first list of channels include instructions which, when executed by the processor, cause the first AP to:
obtain channel condition information regarding a set of channels available for use by the first AP, wherein the channel selection information is based, at least in part, on the channel condition information, and
determine the first list of channels from among the set of channels, the first list of channels selected by the first AP based, at least in part, on a first channel selection by the first AP.

3. The first AP of claim 2, wherein the instructions to obtain the channel condition information include instructions which, when executed by the processor, cause the first AP to:
scan the set of channels; and
determine the channel condition information in response to scanning the set of channels.

4. The first AP of claim 2, wherein the instructions to obtain the channel condition information include instructions which, when executed by the processor, cause the first AP to:
send a query message to at least a second AP in the network; and
receive a response message from the second AP, the response message having at least a portion of the channel condition information.

5. The first AP of claim 2, wherein the instructions to obtain the channel condition information include instructions which, when executed by the processor, cause the first AP to:
send a query message to the Multi-AP Controller in the network; and
receive a response message from the Multi-AP Controller, the response message having the channel condition information regarding one or more other APs in the network.

6. The first AP of claim 1, wherein the channel selection information comprises at least one member selected from the group consisting of:
current channel condition information regarding a channel currently used by a second AP;
operating capability information regarding operating capability of the second AP;
a remote channel switch trigger condition associated with the second AP; and
other channel condition information regarding other channels detected by the second AP.

7. The first AP of claim 1, wherein the instructions, when executed by the processor, further cause the first AP to:
detect a local channel switch trigger condition, wherein the first list of channels is sent in response to a detection of the local channel switch trigger condition.

8. The first AP of claim 7, wherein the instructions to detect the local channel switch trigger condition include instructions which, when executed by the processor, cause the first AP to receive a channel preference query message from the Multi-AP Controller or another AP in the network.

9. The first AP of claim 7, wherein the instructions to detect the local channel switch trigger condition include instructions which, when executed by the processor, cause the first AP to perform at least one operation selected from a group consisting of:
determining that the first AP has a load higher than a trigger threshold;
determining a co-channel interference on a current channel being used by the first AP, wherein the co-channel interference is impacting channel availability for one or more stations associated with the current channel;
comparing an interference power level with a threshold level; and comparing a current time with a trigger time configured at the first AP.

10. The first AP of claim 1, wherein the instructions to send the first list of channels include instructions which, when executed by the processor, cause the first AP to:
select the first list of channels based, at least in part, on the channel selection information; and
associate a preference score for each channel in the first list of channels.

11. The first AP of claim 10, wherein the instructions to select the first list of channels include instructions which, when executed by the processor, cause the first AP to:
for at least one candidate channel from a set of channels:
determine an effective channel capacity for the candidate channel;
determine an estimated load impact to a neighbor AP that is already using the candidate channel; and
determine a probability of triggering a remote channel switch trigger condition of the neighbor AP that would result from the first AP selecting the candidate channel.

12. The first AP of claim 11, wherein the instructions to determine the effective channel capacity for the candidate channel include instructions which, when executed by the processor, cause the first AP to:
determine a current available airtime of the candidate channel utilized by other neighbor APs in an overlapping coverage area that includes the first AP;
determine an additional contention airtime of the candidate channel based, at least in part, on a quantity of stations associated with the first AP and the current available airtime;
determine an estimated physical layer transmission data rate for the quantity of stations associated with the first AP; and
calculate the effective channel capacity based, at least in part, on the current available airtime, the additional contention airtime, and the estimated physical layer transmission data rate.

13. The first AP of claim 11, wherein the instructions to determine the probability of triggering the remote channel switch trigger condition include instructions which, when executed by the processor, cause the first AP to:
determine the remote channel switch trigger condition of the neighbor AP;
estimate a resulting channel condition at the neighbor AP that would result from the first AP selecting the candidate channel; and
compare the resulting channel condition to the remote channel switch trigger condition.

14. The first AP of claim 1,
wherein the instructions to send the first list of channels include instructions which, when executed by the processor, cause the first AP to send a Channel Preference Report message to the Multi-AP Controller, and
wherein the instructions to receive the second list of channels include instructions which, when executed by the processor, cause the first AP to receive a Channel Selection Request message from the Multi-AP Controller.

15. The first AP of claim 1, wherein the second list of channels comprises a subset of the first list of channels selected by the Multi-AP Controller based, at least in part, on a second channel selection by the Multi-AP Controller.

16. The first AP of claim 1, wherein the instructions to utilize the first channel include instructions which, when executed by the processor, cause the first AP to:
select the first channel from among the second list of channels; and
configure a transceiver of the first AP to communicate via the first channel.

17. The first AP of claim 1, wherein instructions, when executed by the processor, further cause the first AP to:
send a channel switch finish message to the Multi-AP Controller to indicate that the first AP is utilizing the first channel.

18. A Multi-AP Controller of a network, comprising:
a processor; and
memory having instructions stored therein which, when executed by the processor cause the Multi-AP Controller to:
receive a first list of channels from a first AP of the network, the first list of channels selected by the first AP based, at least in part, on a first channel selection by the first AP;
determine a second list of channels from among the first list of channels, the second list of channels selected by the Multi-AP Controller based, at least in part, on the first list of channels;
send, to the first AP, the second list of channels to the first AP; and
cause the first AP to utilize a selected channel from the second list of channels.

19. The Multi-AP Controller of claim 18, wherein the instructions, when executed by the processor, cause the Multi-AP Controller to, prior to receiving the first list of channels:
send a Channel Preference Query message from the Multi-AP Controller to the first AP.

20. The Multi-AP Controller of claim 18,
wherein the instructions to receive the first list of channels include instructions which, when executed by the processor, cause the Multi-AP Controller to receive a Channel Preference Report message from the first AP, and
wherein the instructions to send the second list of channels include instructions which, when executed by the processor, cause the Multi-AP Controller to send a Channel Selection Request message to the first AP.

21. The Multi-AP Controller of claim 18, wherein the instructions to determine the second list of channels include instructions which, when executed by the processor, cause the Multi-AP Controller to:
for at least one candidate channel from the first list of channels:
determine an effective channel capacity for the candidate channel;
determine an estimated load impact to a neighbor AP that is already using the candidate channel; and
determine a probability of triggering a remote channel switch trigger condition of the neighbor AP that would result from the first AP selecting the candidate channel.

22. The Multi-AP Controller of claim 18, wherein the instructions to determine the second list of channels include instructions which, when executed by the processor, cause the Multi-AP Controller to:
for at least one candidate channel from the first list of channels:
use a contention graph coloring algorithm to estimate an impact to the network that would result from the first AP selecting the candidate channel.

23. The Multi-AP Controller of claim 18, wherein the instructions to determine the second list of channels include instructions which, when executed by the processor, cause the Multi-AP Controller to utilize a contention graph coloring algorithm to maximize channel reuse in the network.

24. A method performed by a first access point (AP) of a network, the method comprising:
sending a first list of channels to a Multi-AP Controller of the network, the first list of channels including channel selection information determined by the first AP;
receiving, from the Multi-AP Controller, a second list of channels selected by the Multi-AP Controller, wherein the second list of channels is based, at least in part, on the first list of channels; and
utilizing, by the first AP, a first channel from among the second list of channels for providing a first wireless coverage area.

25. The method of claim 24, wherein sending the first list of channels includes:
obtaining channel condition information regarding a set of channels available for use by the first AP, wherein the channel selection information is based, at least in part, on the channel condition information; and
determining the first list of channels from among the set of channels, the first list of channels selected by the first AP based, at least in part, on a first channel selection by the first AP.

26. The method of claim 24, further comprising:
selecting the first list of channels based, at least in part, on the channel selection information; and
associating a preference score for each channel in the first list of channels.

27. The method of claim 24, wherein the second list of channels comprises a subset of the first list of channels selected by the Multi-AP Controller based, at least in part, on a second channel selection by the Multi-AP Controller.

28. A computer-readable medium having stored therein instructions which, when executed by a processor of a first access point (AP) for use in a network, cause the first AP to:
send a first list of channels to a Multi-AP Controller of the network, the first list of channels including channel selection information determined by the first AP,
receive, from the Multi-AP Controller, a second list of channels selected by the Multi-AP Controller, wherein the second list of channels is based, at least in part, on the first list of channels, and
utilize, by the first AP, a first channel from among the second list of channels for providing a first wireless coverage area.

29. The computer-readable medium of claim 28, wherein the instructions to send the first list of channels include instructions which, when executed by the processor, cause the first AP to:
obtain channel condition information regarding a set of channels available for use by the first AP, wherein the channel selection information is based, at least in part, on the channel condition information, and
determine the first list of channels from among the set of channels, the first list of channels selected by the first AP based, at least in part, on a first channel selection by the first AP.

30. The computer-readable medium of claim 28, wherein the second list of channels comprises a subset of the first list of channels selected by the Multi-AP Controller based, at least in part, on a second channel selection by the Multi-AP Controller.
